(19) United States
(12) Patent Application Publication
(10) Pub. No.: US 2025/0045518 A1
(43) Pub. Date: Feb. 6, 2025

(54) ELECTRONIC SYSTEM AND METHOD FOR PROVIDING SUGGESTED REVISED ELECTRONIC COMMUNICATIONS IN REAL TIME BASED ON A RECIPIENT COMMUNICATION STYLE

(71) Applicant: Xylo AI Corp, Minneapolis, MN (US)

(72) Inventors: David Barta, Brooklyn Park, MN (US); Zach Paul Gunderson, Lakeville, MN (US); Roger Lam, Franklin, WI (US)

(73) Assignee: Xylo AI Corp, Minneapolis, MN (US)

(21) Appl. No.: 18/793,556

(22) Filed: Aug. 2, 2024

Related U.S. Application Data
(60) Provisional application No. 63/530,390, filed on Aug. 2, 2023.

(51) Int. Cl. G06F 40/186

(52) U.S. Cl. CPC G06F 40/186

(57) ABSTRACT

Embodiments of the present disclosure relate to a system, software application, and methods for providing an improved electronic written communication that sounds like the user, as well as being tailor-fit to the writing style of the recipient in order to avoid miscommunication caused by personality, clarity, cultural, or generational writing differences. Systems and methods of the present disclosure may enhance written electronic communication through the integration of personalized profiles for both senders and recipients. By leveraging advanced stylometry and behavioral psychology profiling, the system tailors communications to fit individual needs. Additionally, this solution ensures that system-generated content matches the sender's natural writing style, saving time and maintaining authenticity. The system also provides real-time feedback and adjustments to avoid potential communication frictions. Moreover, embodiments of the present disclosure bridge miscommunication gaps caused by cultural and generational differences by interpreting these nuances and incorporating them into the improved electronic written communication.

### CROSS-REFERENCE TO RELATED APPLICATIONS

This application claims the benefit under 35 U.S.C § 119 (e) of provisional application 63/530,390, entitled, “A System and Method for Providing Suggested Revised Language Based on a Recipient's Communication Style,” filed, Aug. 2, 2023, the entire contents of which is incorporated by reference herein in its entirety.

### TECHNICAL FIELD

The present disclosure in some embodiments relates to electronic, software and/or hardware-based systems and methods for providing in real time suggested changes to an electronic mail or other communication based upon the communication style of the intended recipient of the communication. In some embodiments, the present disclosure uses artificial intelligence and/or natural language processing to generate improved responses to electronic communications from a sender. More particularly, in some embodiments, the present disclosure includes targeting enhancements in written electronic communication through personalized profiling and emotional intelligence enrichment.

### BACKGROUND

Electronic communications, such as electronic mail, text, and/or chat or instant messaging are routinely used—by most people on a daily basis-both in the work environment and outside of the work environment. It is well understood that people have different communication styles, based on a variety of factors, including living location, age, upbringing, personality, life experience, etc. Psychologists, sociologists, and others have conducted extensive research to identify and categorize primary, secondary, et cetera communication styles that generally could apply to everybody. Many of the frameworks developed use four primary communication types. For example, four major communication styles have been modeled by DISC (DISC is an acronym with the first letter of each style-Dominance, Influence, Steadiness, and Conscientiousness). Further, Social Styles is another framework that categorizes communication styles into four types: Driving, Expressive, Amiable, and Analytical. While the two models use different terms to describe the four styles, the models generally correlate with one another. For example, Social Styles (SS) Driving=DISC Dominance: SS Expressive=DISC Influence: SS Amiable=DISC Steadiness: SS Analytical=DISC Conscientiousness. The two models present communication style information in some cases using a graph with an x-axis and y-axis. The two axes describe people/emotional-oriented attributes versus data/task-oriented attributes on one axis and tell/aggressive versus ask/passive on the other axis.

Miscommunication in emails is widespread, primarily due to the fact that written electronic communication does not occur face-to-face, which may severely impair the ability to pick up emotional and other important cues in a conversation. This problem is amplified in remote and hybrid work scenarios where face-to-face interactions are limited. The lack of tailored communication often leads to misunderstandings, reduced productivity, and strained professional relationships. Furthermore, cultural and generational differences, as well as language barriers among global teams may compound miscommunication issues. Most people do not have the time—and many people may not have the ability—to tailor each piece of writing to fit the recipient's communication style: nor are most people conscious of the personality or cultural differences that may necessitate updates to their written communication to avoid miscommunication.

The prevalence of remote, hybrid, and multi-location work environments has significantly increased the importance of effective written communication. Global teams often consist of individuals who are non-native English speakers, which can exacerbate misunderstandings. Traditional communication tools facilitate message exchange, but frequently fail to address individualized communication needs, resulting in generic and sometimes ineffective electronic interactions.

This problem is also present when the author does not know the recipient(s) of an electronic communication and has no way of knowing the recipient's communication type. For instance, a person working remotely may be communicating with co-workers he/she has never met. Businesses may lose money because of miscommunications in written communications between co-workers and third parties because the author does not craft the written communication to be consistent with the communication type of the recipient.

Thus, there is a need for systems and methods that can identify and categorize the communication type of a recipient of an electronic communication and automatically suggest modifications to a communication such as an e-mail based on the communication type of the recipient or primary recipient to improve electronic communication between people.

### SUMMARY OF THE INVENTION

In some embodiments of the present disclosure, the method includes providing an improved electronic communication, where the method includes receiving a plurality of sample electronic communications for a recipient and then determining via a style identification engine a communication profile for the recipient based on the plurality of sample electronic communications. The method also includes receiving an initial electronic communication from a user to the recipient and then revising the initial electronic communication via an improved response generation engine to produce a suggested improved electronic communication that better reflects the recipient's determined communication profile. The suggested improved electronic communication is then provided to the user.

The method may also include the step of determining the communication profile of the recipient includes sending the style identification engine explicit definitions for a plurality of communication styles that make up the communication profile. In some embodiments, the method may further include producing at least one action item for the user based on the initial or the improved electronic communication, and providing the at least one action item to the user.

In still other embodiments, the method includes producing at least one action item for the recipient based on the initial or the improved electronic communication and providing the at least one action item to the user.

In some embodiments, the method includes an initial electronic communication that includes a plurality of individual electronic communications.

In some embodiments, the method also includes providing to the user a summary of the initial electronic communication, wherein the summary is provided according to the determined communication profile of the recipient.

In some cases, the method includes providing on a user-interface of a computing device of the user the ability to accept, reject, or revise the improved electronic communication.

Some embodiments of the method further include, the plurality of sample electronic communications from the recipient numbering at least four.

The method may include the suggested improved electronic communication being for an entirety of the initial electronic communication.

In some embodiments of the method, the suggested improved electronic communication is for a portion of the initial electronic communication.

In some embodiments of the present disclosure, a system for providing an improved electronic communication that is tailored to a determined communication style of an intended recipient of the electronic communication is provided, where in the system includes: a database to store a plurality of sample communications from at least one user: a style identification engine, including software programmed such that when it is executed the style identification engine provides a determined communication style for each of the at least one user based on the stored plurality of sample communications of each of the at least one user, wherein the style identification engine includes a large language model module that receives explicit definitions for a plurality of communication types that make up the determined communication style; and an improved response generation engine, including software programmed such that when it is executed, the improved response generation engine provides the improved electronic communication that includes changes from an initial electronic communication where the changes are in the determined communication style of at least of the users that is the intended recipient of the improved electronic communication.

In some embodiments, the system also includes the user being an employee of a company, and wherein the initial electronic communication is a work-based communication.

The system may further include an administrative panel module that is accessible by an administrator of the company, the administrative panel module including at least one policy document provided by the administrator of the company for use by the improved response generation engine.

In some embodiments, the system may include the at least one policy document being a template that is used by the improved generation engine in providing the improved electronic communication.

In some embodiments, the at least one policy document includes at least one rule that is used by the improved generation engine to control a set of language that can be included in the improved electronic communication.

In some embodiments, the at least one rule prohibits the use of one or more words.

In some embodiments, the at least one rule defines at least one acronym.

The system according to some embodiments includes the improved generation engine providing to the user a summary of the improved electronic communication, and also provides at least one action item based on the initial electronic communication.

The system may further include where the summary and the at least one action item are provided in any chosen language.

In some embodiments, the system may further include a verify and correct engine that receives the improved electronic communication from the improved response generation engine, the verify and correct engine including software that when executed identifies further improvements that can be made to the improved electronic communication, where the further improvements are based on the determined communication style of the recipient.

### BRIEF DESCRIPTION OF THE DRAWINGS

While the specification concludes with claims particularly pointing out and distinctly claiming the subject matter that is regarded as forming the various embodiments of the present disclosure, it is believed that the disclosure will be better understood from the following description taken in conjunction with the accompanying Figures, in which:

FIG. 1 shows a screenshot illustrating various attributes of some embodiments of the present disclosure, as would be seen by a user of the system;

FIG. 2 illustrates a screenshot that summarizes an email thread and extracts action items from an email thread in one of several languages, according to some embodiments of the present disclosure:

FIG. 3 shows a block diagram of a system of the present disclosure, according to some embodiments of the present disclosure:

FIG. 4 shows a flow diagram of a method of the present disclosure, according to some embodiments:

FIG. 5 shows a screenshot of the system providing a user a revised email that better reflects the recipient's communication style, according to some embodiments of the present disclosure:

FIG. 6 shows a graphical comparison of providing the improved response generation engine with explicit definitions of communication styles versus not providing such definitions, according to some embodiments of the present disclosure:

FIG. 7 shows a graphical comparison of providing the improved response generation engine with variable versus fixed prompts, in accordance with some embodiments of the present disclosure.

FIG. 8 shows a screenshot of systems and methods of the present disclosure that provide insight into characteristics of a user's contacts and provides historical information as well, according to some embodiments.

FIG. 9 shows a screenshot of systems and methods of the present disclosure that provide templates for a user to aid in assisted and/or automated document creation, according to some embodiments.

FIGS. 10A and 10B show screenshots of systems and methods of the present disclosure that allow a user to define and/or provide rules for words or phrases to assist in communication creation, according to embodiments of the present disclosure.

FIG. 11 shows a screenshot of systems and methods of the present disclosure hat allows a user to create a template to aid in communication creation, according to embodiments of the present disclosure.

### DETAILED DESCRIPTION

Embodiments of the present disclosure include systems and methods to improve electronic communication. More specifically, systems and methods of the present disclosure improve electronic communication by providing suggestions for improvements to electronic communication that better reflect the communication style of the recipient of the communication but are still in the style of the sender. In some embodiments, systems and methods of the present disclosure leverage the use of artificial intelligence (AI), machine learning, and/or natural language processing (NLP).

While embodiments may be described with references to electronic mail, or e-mail, it will be understood that systems and methods of the present disclosure may be used with any form of electronic communication, including, but not limited to text, chat, instant messaging, word processing document creation and exchange, and/or any other form of electronic communication. Further, while embodiments of the present disclosure may be described with reference to work-based communication, it will be understood that the present disclosure applies equally to other forms of electronic communication, such as personal communication, or any other communication between people who may not be co-works, but rather may be friends, family members, neighbors, members of an association, a service provider and customer, and/or any other type of electronic communication that may occur between two or more people.

Communication between people, including between co-workers, may be more effective if the message is written to comport with the communication style of the recipient. Typically, people do not always effectively craft electronic communication to take into account the communication type of a recipient. Systems and methods of the present disclosure include generating writing that sounds like the user, as well as tailor-fitting the writing to avoid miscommunication caused by personality; clarity; cultural, or generational writing differences, for example. According to some embodiments, systems and methods include enhancing written communication through the integration of personalized profiles for both senders and recipients. By leveraging advanced stylometry and behavioral psychology profiling, the system tailors communications to fit individual needs. Additionally, embodiments of the present disclosure ensure that AI-generated content matches the sender's natural writing style, saving time and maintaining authenticity. In some embodiments, the system may also provide real-time feedback and adjustments to avoid potential communication frictions. Moreover, systems and methods of the present disclosure may bridge miscommunication gaps caused by cultural and generational differences by interpreting cultural and generational-based nuances and incorporating them into the writing.

In some embodiments of the present disclosure, the inventive system can generate writing that sounds like the user, as well as tailor-fit the writing to avoid miscommunication caused by personality, clarity, cultural, or generational writing differences. Methods of the present disclosure may enhance electronic written communication through the integration of personalized profiles for both senders and recipients. By leveraging advanced stylometry and behavioral psychology profiling, the system may tailor communications to fit individual needs. Additionally, embodiments of this solution may ensure that AI-generated content matches the sender's natural writing style, saving time and maintaining authenticity. The system also provides real-time feedback and adjustments to avoid potential communication frictions. Moreover, systems and methods of the present disclosure may help bridge miscommunication gaps caused by cultural and generational differences by interpreting these nuances and incorporating them into the writing.

In some embodiments, systems and methods of the present disclosure include one or more of the following benefits over traditional electronic communication exchange: personalized communication that includes improved written communication by tailoring messages to the recipient's profile: style matching by generating content in the sender's style from brief descriptions, ensuring AI-generated text matches the sender's natural writing style: tailored responses by offering full tailored email responses within a reply chain: feedback and nudges providing recipient-unique feedback on tone, clarity, politeness, and personalization, and nudge rewrites to avoid communication frictions: enhanced summarization that summarize email threads and extract actionable items: administrative management that allows the administrator to manage company-specific documentation through an administrative panel; meeting scheduling that automatically recognizes the need to schedule meetings based on email content and provides scheduling capabilities: cross-platform functionality that supports the use across various communication clients such as Outlook, Gmail, Slack, and Teams, for example: privacy preservation that extracts and uses certain traits for emotional intelligence enhancement without storing any customer email content: team collaboration that includes enhanced draft and rewrite functions through team-shared documents, enabling quick retrieval of accurate product information; and/or custom templates with specific documents for consistent and efficient email drafting.

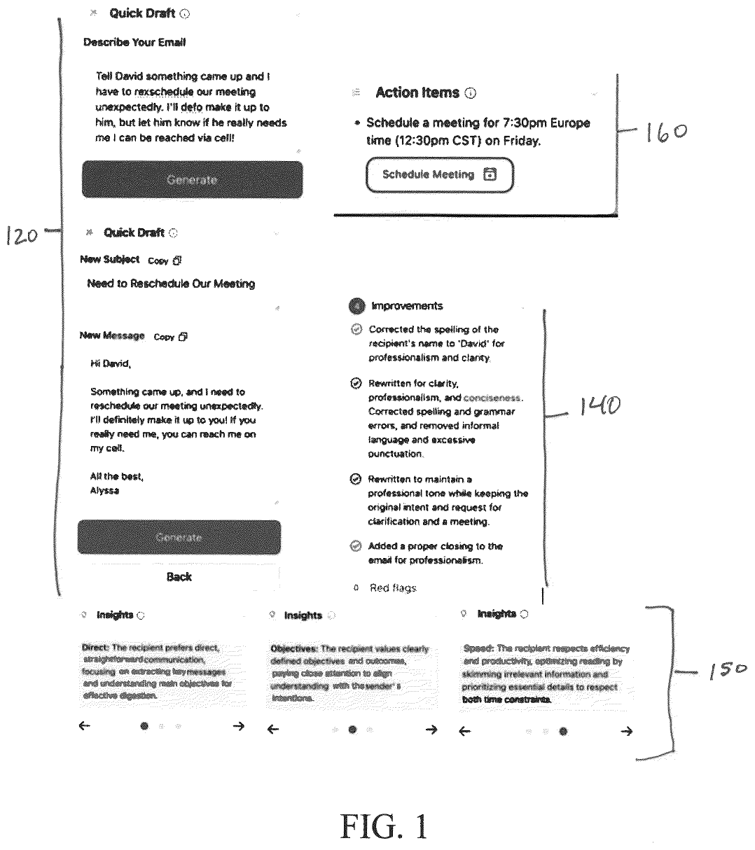

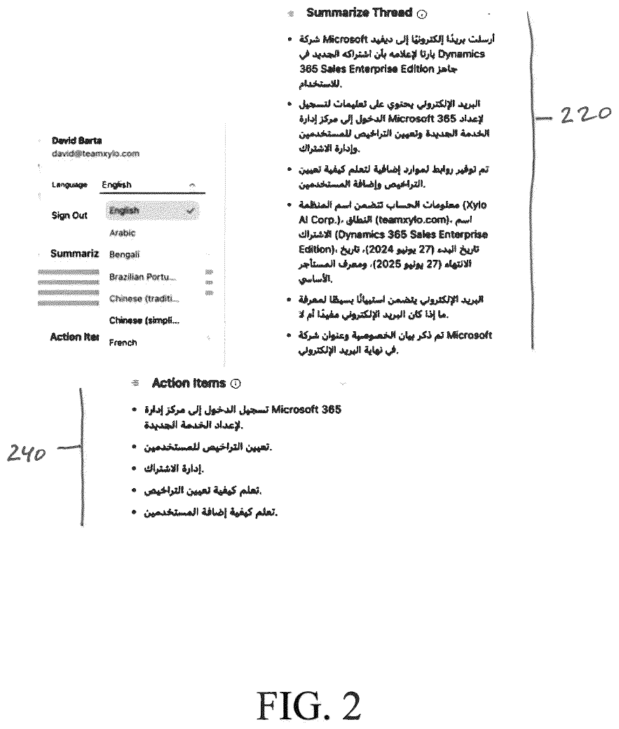

Systems and methods of the present disclosure in some embodiments may include, or may also include, one or more of the following features as shown with reference to FIG. 1: Email Rewriting: the system may rewrite email drafts 120 to better tailor them to the recipient's profile 150. This may include adjusting the tone, style, and content to ensure clarity and appropriateness 140: Style Matching: the system may generate full tailored emails in the sender's style from brief descriptions 120. By leveraging user-specific stylometry; the generated content may closely match the natural writing style of the sender, ensuring authenticity: Stylometry-Based Writing: in some embodiments the system uses an advanced stylometry and natural language processing (NLP) process to ensure artificial intelligence (AI)-generated content that matches the sender's natural writing style, saving time and enhancing authenticity: Communication Style Management: the system in some embodiments stores different personal styles such as professional and casual, auto-generates these styles, and allows for fine-tuning by the user. This feature helps users maintain consistency in their communication: Reply Chain Tailoring: provides full tailored email responses within a reply chain, taking into account the context and previous exchanges to ensure coherence and relevance; Feedback and Suggestions: offers recipient-specific feedback and suggestions on tone, clarity; politeness, and personalization 140, 150. Additionally; the system may provide nudges and suggestions for rewrites to avoid potential communication frictions: To-Do Extraction: automatically extracts actionable items from email threads, helping users keep track of tasks and follow-ups efficiently: Meeting Scheduling: recognizes the need to schedule meetings based on email content and provides the user with quick scheduling options, streamlining the process 160: Cross-Platform Functionality: supports use across multiple email clients, for example, with Outlook and Gmail, ensuring consistent user experience regardless of the platform used; Nudging for Communication Efficiency: detects potential communication frictions based on personality; cultural, and generational differences, providing nudges and rewrite suggestions to avoid these frictions and enhance communication efficiency: Privacy-Preserving Data Extraction: the system may extract and utilize only the necessary traits for emotional intelligence enhancement without storing any customer email content. This approach ensures user privacy and data security: Team Document Sharing for Retrieval-Augmented Generation (RAG): utilized shared documents within teams to enhance the draft and rewrite functions. By retrieving accurate product or company-specific information mentioned in emails, the system reduces repetitive detail inputs, ensuring efficient communication: Custom Templates: allows users to create and use custom templates in conjunction with specific documents to streamline email writing and maintain consistency across communications: Multilingual Summarization: summarizes email threads in multiple languages, providing concise overviews 240 and extracting actionable items 220, as shown in FIG. 2. This is particularly useful for global teams that deal with emails in various languages.

Generally; according to some embodiments, systems and methods of the present disclosure may review and analyze sample communications, such as five or more electronic communications from an individual to determine a communication type or style for the individual. In the work environment, this methodology may be used to determine the communication type of each employee, for example, or in other cases, some subset of employees. Over time, the system may continue to analyze communications of each user/employee to refine the communication type for each individual.

Then, in one embodiment, based on the communication type of recipient or primary recipient as determined by the system, the system recommends modifications to a draft communication to make it more consistent with the communication style of the recipient or primary recipient's determined communication style. For instance, when an employee writes an email to a certain email address (e.g., bob@work.com), the system reviews the draft to Bob, and based on Bob's communication type as determined by the system, the system suggests modification to the draft e-mail that models Bob's communication style. The result of the review is that before the employee hits “send,” the employee's email to Bob is rewritten by the system to match Bob's communication style, enabling Bob to better understand the received communication.

The present invention may be used with any written electronic communication, not just e-mails. Further, a person's communication style can be different based on the written communication form. Systems and methods of the present disclosure may include multiple communication styles and sub-styles based on the form of communication utilized, for example, text/chat (over Slack or Teams, for example) versus email (over Outlook or Gmail, for example) and then provide suggested modifications to the author based on the communication form and type of the recipient.

In one embodiment of the present disclosure, the system determines the communication style of an individual or a group of individuals, for example each employee in a company, or each member in a family by using electronic communication samples, for example e-mails. For example, in the work context, the system determines each employee's communication type based on prior written electronic communications. In one embodiment, an employee's communication type is determined with prior written samples used in the communication mode. For instance, in one embodiment, for e-mail communications, a user's prior e-mails are used to determine the user's communication type. Because people fall into different communication types, in one embodiment, the system includes a profiling method that places each person in one of four quadrants of communication types, for example. In one embodiment, the system uses the following four communication types: 1) Data-Ask style, the 2) Data-Tell style, the 3) People-Ask style, and 4) the People-Tell style. In other embodiments, the system profiles individuals based on ask/tell and emotive/control frameworks. In one embodiment, the system analyzes a person along two continuums, the assertiveness (one end would be ask/passive, the other end tell/aggressive) and the emotive (one end would be task/controlled emotions, the other side would be emotional/expressive/people/relationship oriented). In still other embodiments, the system profiles individuals based on other known or later arising categories of communication style.

Systems of the present disclosure may use stylometry to assess an individual's communication style and/or provide suggested improvements to an electronic communication. Specifically, systems may include using NLP to analyze and store unique writing patterns, structures, and styles of users in vectors and metadata. The system may also include a machine learning engine that may include public and/or proprietary information and methods and may learn and store communication, and in some embodiments may also store behavioral psychology profiles of users. The system may further include one or more databases for storing different personal styles such as professional and casual styles. The system may provide suggested improvements to a communication based on matching the communication style of a recipient and stored writing patterns for a particular communication style, thereby allowing a sender to accept or deny a given suggestion and/or fine tune a suggested improvement. The suggested improvements are provided seamlessly and in substantially real-time.

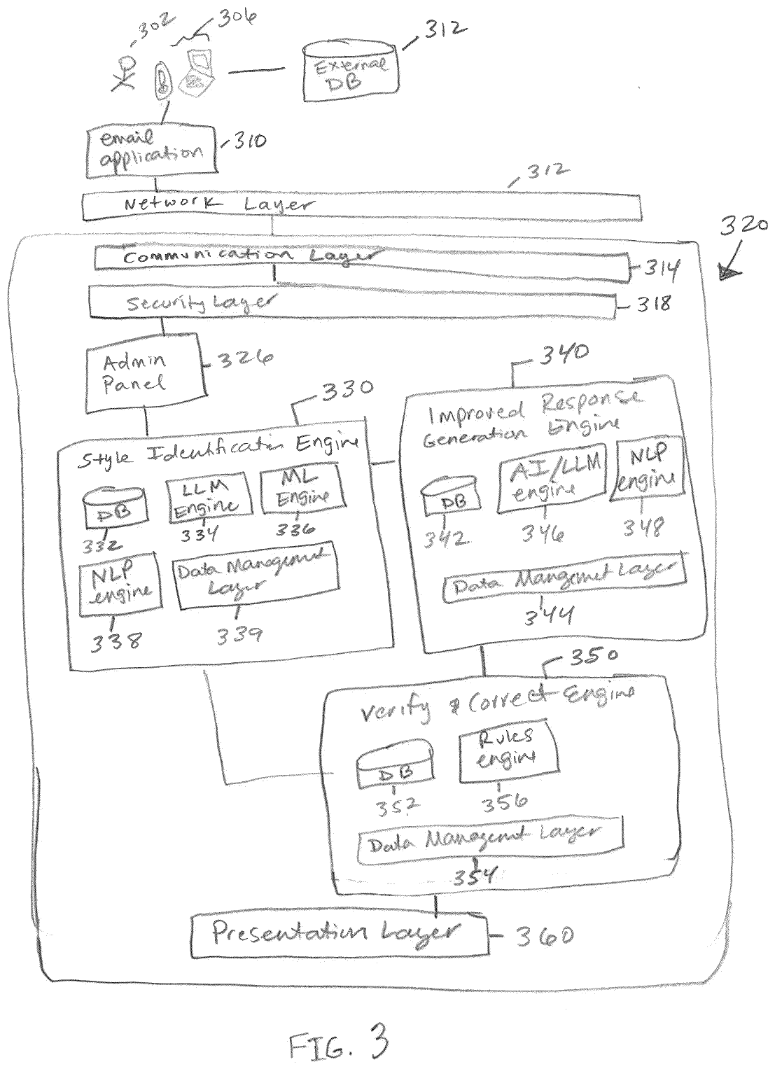

FIG. 3 shows a diagram of a system of the present disclosure according to some embodiments. As may be seen, a user may use a computing device 306, for example a computer, cell phone, tablet, etc. to access a communication program 310, such as an email program that may have access to an external database 312 that may store saved electronic communications, such as e-mails, for example. The communication program 310 may include a system application controller within it or the user 302 may download an application to use in conjunction with the communication program. The computing device 306 may be in communication with the improved communication system 320 via a communication layer 314 over a network 312. An administrative interface may be accessed through the administrative panel 326 by a user or a user's designated or appointed and authorized administrator, such as an employer administrator. Sample communications for a user or users that may be stored in an external database 312 for example may be forwarded to the Style Identification Engine 330 of the improved communication system 320. A security layer 318 ensures that the system 320 does not retain any information from the sample communications that is not necessary; and/or that is protected, confidential, or otherwise should not be provided or accessible by the system after the style identification engine 330 uses the content to determine the communication style of a user. The style identification engine 330 may use a number of modules to determine the communication style of a user from the sample communications provided to the engine 330. For example, the engine 330 may include one or more databases 332 for storing, or temporarily storing, sample communications, and/or communication style information, etc., along with a data management layer 339 that helps facilitate data movement through one or more modules of the engine 330. The engine 330 may include a large language model module 334, a machine learning engine module 336, and/or a natural language processing engine module 338, which are each discussed in more detail herein. The engine, through the use of the modules, provides a communication profile for a user that may be stored in a database 332 that is then sent to or accessed by the improved response generator engine 340 that may provide an initial communication or improved communication based on a recipient's communication profile and in response to a prompt from a user 302 or the system 320. The improved response generator engine 340 may include one or more databases 342 and a data management layer 344, in addition to one or more modules, including but not limited to an AI engine 346 that may incorporate therein an LLM module, and/or a NLP engine 348. In some embodiments, the output of the improved response generator engine 340, which may be an entire improved communication, and/or portions of an improved communication, may then be sent to or accessed by the Verify and Correct Engine 350, which may review and correct, and/or improve the output from the Improved Response Generator Engine 340. The Verify and Correct Engine 350 may include one or more databases 352 and a data management layer 354, along with at least one rules engine 356 that includes one or more sets of rules for ensuring that the improved communication is in line with the recipient's communication style, and/or is in compliance with a company's policies regarding electronic communications or other polices, for example. The results of the Verify and Correct Engine 350 may then be sent or accessed by the presentation layer 360 which may format and prepare the results for the user 302, and which then may be accessed by the user 302 via their communication device 306.

The term “code” or “algorithm” can include software or firmware. It can refer to one or more programs, routines, functions, and/or objects. Some or all code from multiple modules or engines can be stored by a single shared memory. The apparatuses, methods, and systems described herein can be implemented by one or more computer programs executed by one or more processors. The computer programs may include processor-executable instructions that may be stored on a non-transitory, tangible, computer-readable medium. The computer programs can also include stored data. Examples of non-transitory, tangible, computer-readable medium, include but are not limited to nonvolatile memory; magnetic storage, and optical storage.

The terms “database” or “storage device or engine” as used herein refer to either a body of data, a relational database management system (RDBMS), or both. A database or storage engine may comprise any collection of data including hierarchical databases, relational databases, flat file databases, and any other structured collection of records or data that may be stored in a computing system, including but not limited to Oracle, MYSQL, IBM, DB2, SQL Server, POSTGRESQL, Microsoft, SYBASE, or any other database that enables the systems and methods described herein.

The hardware layer of the system can include one or more central processing units (CPUs), memory controllers, and other devices, components, or elements of a computer system such as volatile or nonvolatile memory, nonvolatile storage, including disk and I/O devices or interfaces. This layer may further include programmed instructions that are configured to support virtualization, containerization, or other technologies.

With continued reference to FIG. 3, the computer system of the present disclosure 320 may use one or more computing devices 306, including mobile computing devices. Note that embodiments of systems of the present disclosure may include each component disclosed regardless of whether each component is shown in FIG. 3 or other figures, and similarly may include components configured in alternate disclosed configurations than those shown in FIG. 3. The system and/or external data server(s) may be implemented using two or more processors, cores, clusters, or instances of physical machines or virtual machines configured in a discrete location or co-located with other elements in a datacenter, shared computing facility or cloud computing facility. In some embodiments, the external data server may be incorporated within the system.

The implementation of the functions described in the present disclosure using one or more computer programs or software elements that are loaded into and executed using one or more general purpose computers may cause the general-purpose computer(s) to be configured as a particular machine or as a computer that is specially adapted to perform the functions described herein.

In some embodiments, the system may be available on a mobile application or “app” that includes an integrated software platform or controller. Instructions in the main memory of the computer system may be enacted when the app is loaded for execution. The instructions can be stored in, for example, RAM or other main memory, or one or more blocks of disk storage or other non-volatile storage. In one embodiment, the app comprises, for example, instructions for receiving, translating, and ingesting input data via manual upload, external application programming interfaces (APIs) that push data to the app, or instructions that call APIs of external systems to pull data into the app.

In one or more embodiments, the methods and systems can be implemented by one or more special-purpose computer devices. They may be hard-wired to perform the methods or may include digital electronic devices such as one or more application-specific integrated circuits (ASICs) or field programmable arrays (FPGAs) that are persistently programmed to perform the methods, and/or may include one or more general purpose hardware processors programmed to perform the methods according to program instructions in firmware, memory, other storage, or a combination thereof. Such special-purpose computing devices may also combine hardwired logic, ASICs or FPGAs with custom programming to accomplish the methods. The special-purpose computing devices may be desktop computer systems, portable computer systems, handheld devices, networking devices or any other device that incorporates hard-wired and/or program logic to implement the methods.

The computing device may include a bus or other communication mechanism for communicating information, a hardware processor coupled with the bus for processing information, a main memory, such as RAM or other dynamic storage device coupled to the bus for storing information and instructions to be executed by the processor, a read-only memory (ROM) or other static storage device coupled to the bus for storing static information and instructions for the processor, and/or a storage device, for example a magnetic disk, optical disk, or SSD coupled to the bus for storing information and instructions.

In some embodiments, the computing device may also include a display, such as a monitor to display information to a computer user, and/or an input device, such as keypad, mouse, etc. coupled to the bus for communicating information and command selections to the processor.

The computing device may also include hardwired logic, one or more ASICs or FPGAs, firmware and/or program logic to implement the methods of the present disclosure that in combination with the computer system causes or programs the entire system to be a special-purpose machine.

In some embodiments, the system may include performing methods by the system in response to the processor executing one or more sequences of one or more instructions contained in the main memory. Such instructions may be read into the main memory from another storage medium, such as a storage device.

Execution of the instructions in the main memory causes the processor to perform the process steps disclosed herein. In other embodiments, hardwired circuitry may be used in place of or in combination with software instructions.

The system may also include a communication interface 314 coupled to the bus. The communication interface may provide a two-way data communication coupling to a network, network link 312 that is connected to a local network, for example, the communication interface 314 may be an integrated services digital network (ISDN) card, cable modem, satellite modem, or a modem to provide a data communication connection to a corresponding type of telephone line. As another example, a communication interface may be a local area network (LAN) card to provide a data communication connection to a compatible LAN. Wireless links may also be used. In any such use, the communication interface may send and receive electrical, electromagnetic or optical signals that carry digital data streams representing various types of information.

A network link 312 may provide data communication through one or more networks to other data devices. For example, a network link may provide a connection through local network(s) to a host computer or to data equipment operated by an Internet Service Provider (ISP). The ISP in turn may provide data communication services through the Internet. Local network and Internet both may use electrical, electromagnetic or optical signals that carry digital data streams. The signals through the various networks and the signals on network link and through communication interface, which carry the digital data to and from the system are example forms of transmission media.

The system may send messages and receive data, including program code through the network(s), network link 312 and communication interface 314. The received code may be executed by the processor as it is received, and/or stored in the storage device, or other non-volatile storage for later execution.

In some embodiments, the system architecture may include deploying the application on Kubernetes clusters, for example, with globally scalable containers and in some embodiments, it may also be deployed on dedicated Virtual Machines (VMs). The backend APIs of the system may be hosted within these containers, which may securely interface with Large Language Model (LLM) endpoints, such as those provided by Azure OpenAI services, for example. The system in some embodiments, may be designed to be LLM-agnostic, allowing seamless upgrades to more advanced or other models as they become available or to specific domain models tailored for areas like healthcare, law, or finance based on user requirements, for example.

In some embodiments, the system may incorporate a Machine Learning (ML) pipeline that manages its ML models through distributed cloud-based, load-balanced infrastructure. The approach of Retrieval-Augmented Generation (RAG) may be applied by storing user document embeddings in a vector database in some embodiments. Elasticsearch may then be utilized to retrieve the most relevant data during AI text generation, according to some embodiments.

In some embodiment of systems and methods of the present disclosure, a mobile application may interact with the system API to facilitate on-the-go task completion. For instance, the application can quickly generate email replies that sound like the user by processing just a few bullet points, in some embodiments. By leveraging speech-to-text integration with the system API, in some embodiments users can verbally input their main points, allowing the application to generate a professionally written email with the right context. Additionally, with the system's summary API, the application can provide email summaries via AI-generated text-to-speech, which the user can listen to while on the move, with options to select the preferred language.

In another embodiment, a web application may use the system API and user data to provide a daily summary view, for example. This daily summary in some embodiments, may include personalized analyses, prioritized based on the user's needs via the summary API. In some embodiments, the application can extract actionable items from new emails, summarizing and prioritizing them for quick access, allowing users to easily identify emails that need immediate attention.

In one embodiment, a web application may interact with the system API and user data to scale professional communication authentically for social media posts. This application can plan and generate authentic-sounding posts, which can then be scheduled for posting on platforms such as LinkedIn. This ensures consistency and scaling of communication efforts across various social media platforms.

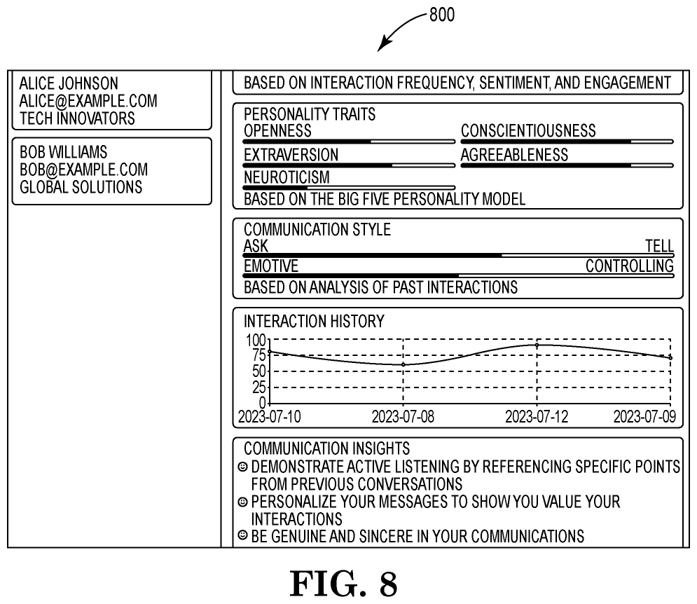

In another embodiment, a web application may pull data from multiple communication sources (e.g., Outlook, Gmail, Slack, and LinkedIn) and utilize the system API to analyze these communications. As may be seen in FIG. 8, the application may provide users with insights into the behavioral psychology of a user's contacts and recommend effective communication strategies for communicating with those contacts 800. The system may also analyze engagement over time, offering recommendations for optimizing communication based on past interactions 800.

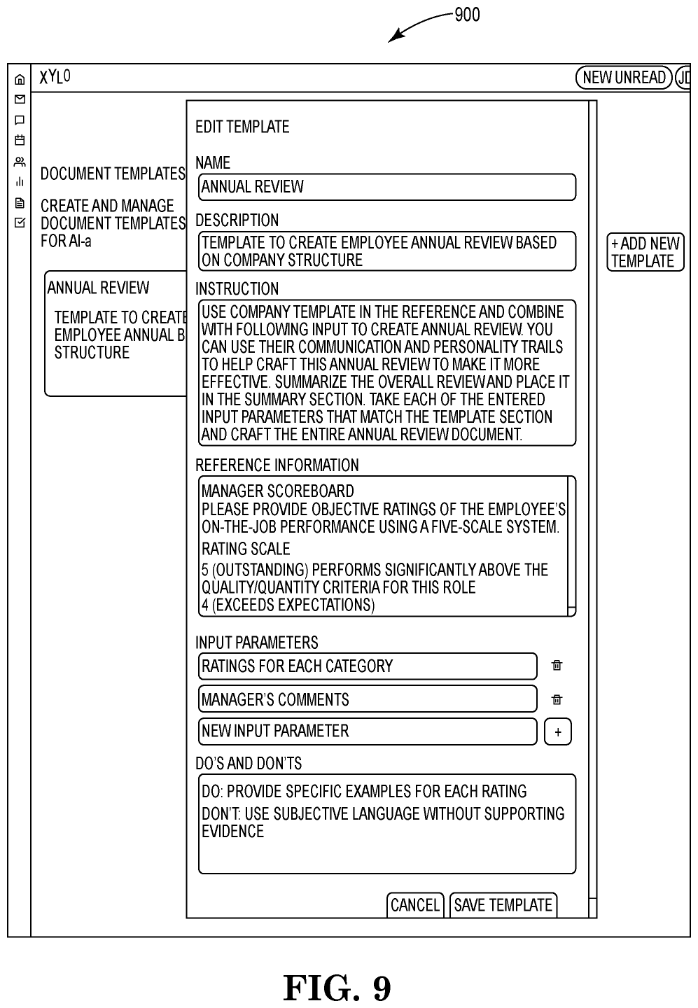

In one embodiment, a web application integrates with the system API and user data to create templates and automate document generation, as is shown in FIG. 9. For example, it can generate annual employee reviews that sound authentically like the user while ensuring the content is personalized and more likely to be well-received by employees 900. This application may streamline the document creation process, ensuring consistency and personalization in all generated texts.

In one embodiment, connecting the system API to short-form communication applications such as Slack, Microsoft Teams, and Twitter, for example may allow for real-time analysis of individuals the user is communicating with. This integration can generate warnings, suggestions, and corrections for example, on the fly, aiding the user in becoming a more effective communicator and reducing communication friction. For example, the API can analyze the tone and sentiment of messages in real-time, providing the user with prompts to adjust their language for better communication outcomes. Templates to generate user specific context for these short form communications may be able to integrate with the system API to generate common answers and replies that are detailed and professional, in some embodiments.

In another embodiment, integrating the system API with AI bots can significantly enhance the naturalness and adaptability of bot-generated text. This integration may allow the AI bots to modify their tone and style dynamically based on the recipient of the communication. This capability is particularly beneficial in scenarios such as customer service and Q&A, where chatbots are extensively used. For instance, an AI bot interacting with a frustrated customer can adopt a more empathetic tone, whereas a bot handling a straightforward inquiry can maintain a professional and concise style.

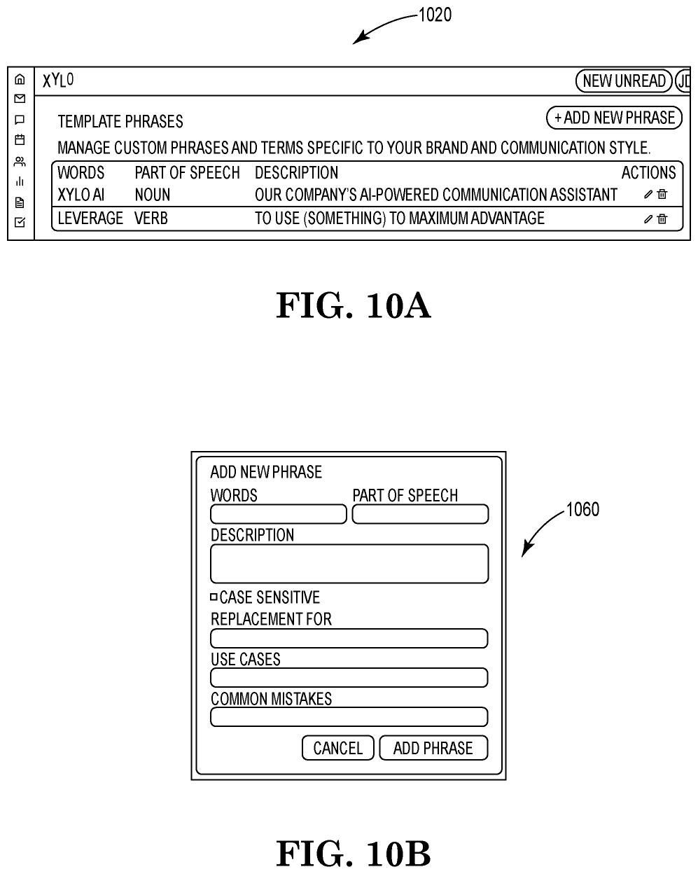

In one embodiment, the application may integrate with the system API to assist brands and writers by managing “Phrases” with specific rules that can be entered and shared within teams 1040, as may be seen in FIGS. 10A and 10B. These rules may guide AI-generated text to avoid common mistakes and ensure adherence to the company's brand guidelines. For example, rules can enforce correct capitalization of company or product names, ensure the confidentiality of sensitive customer or project names, and prevent their accidental disclosure 1020. This functionality can be pivotal in upholding the company's branding consistency and mitigating risks associated with inappropriate information sharing. The application can provide customized Red-Flag warnings to users as they compose messages, alerting them if they deviate from established brand rules or use restricted phrases.

In one embodiment, Customer Relationship Management (CRMs) may integrate with the system API to utilize one or more core ML inferencing models to enhance personal and effective engagements by leveraging behavioral psychology insights by sending data from the CRM, such as Salesforce, for example, to the system API. Through webapp or a separate CRM panel, for example, users can access individual psychology profiles and communication improvement recommendations that may provide a deep understanding of each contact's communication style, leading to more meaningful and impactful interactions.

Training in the Flow of Work: In some embodiments, the system integrates gamification and real-time feedback to provide continuous training in communication skills. Users may receive instant feedback on their communication effectiveness across various channels, helping them improve over time. This may be integrated with an API connection to one or more system Machine Learning Inferencing Models. For example, emails written that match a recipient's style may be given a higher score, and application users may challenge themselves to get a higher score without needing application assistance.

Sales Automation with Behavioral Insights: In another embodiment, the system may use behavioral psychology to provide communication insight for individual contacts, increasing the effectiveness of sales communications. This may be integrated into Sales Engagement Platforms and other similar programs via the API to power their core functionality with insights powered by the system Machine Learning Inferencing Models.

Customer Feedback Analysis: In another embodiment, customer feedback that may be either from email, website form submission, or other written documents may be analyzed. The system may provide nuanced communication insights and recommendations for improving customer satisfaction and engagement. Integration may be achieved via API or web application to the system Machine Learning Inferencing Models.

Improve new employee communication: In another embodiment, the system may use existing communication models and branding templates shared within the organization to improve the onboarding speed of individuals. New users, instead of having to learn to adapt to copy Acronyms, branding style, and specific user communication preference, can come in and already write in a level much more adapted to the organization.

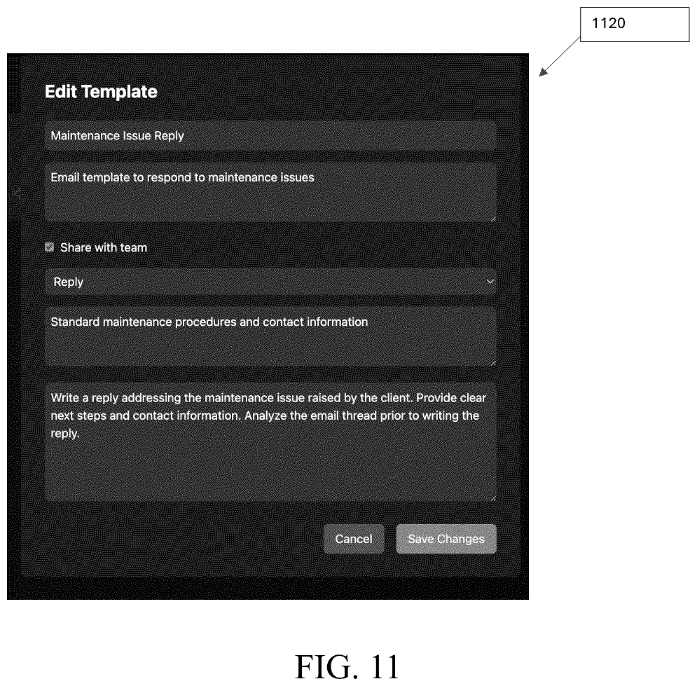

Customer Support Enhancement: In another embodiment, the system can integrate with customer support platforms, the system can use behavioral insights to tailor responses, as well as company specific documents such as product manual, repair guides, and detail support documents. The system may allow users to create specific documents and email reply templates 1120 to avoid problematic or inaccurate replies to customers, as may be seen in FIG. 11.

Personalized Leadership Communication: In some embodiments, the system may assist leaders in crafting department or company memos tailored to different groups. The system may use sentiment analysis and psychological profiles, for example to enhance the effectiveness and reception of communications. Integration may be achieved via API to the system Machine Learning Inferencing Models.

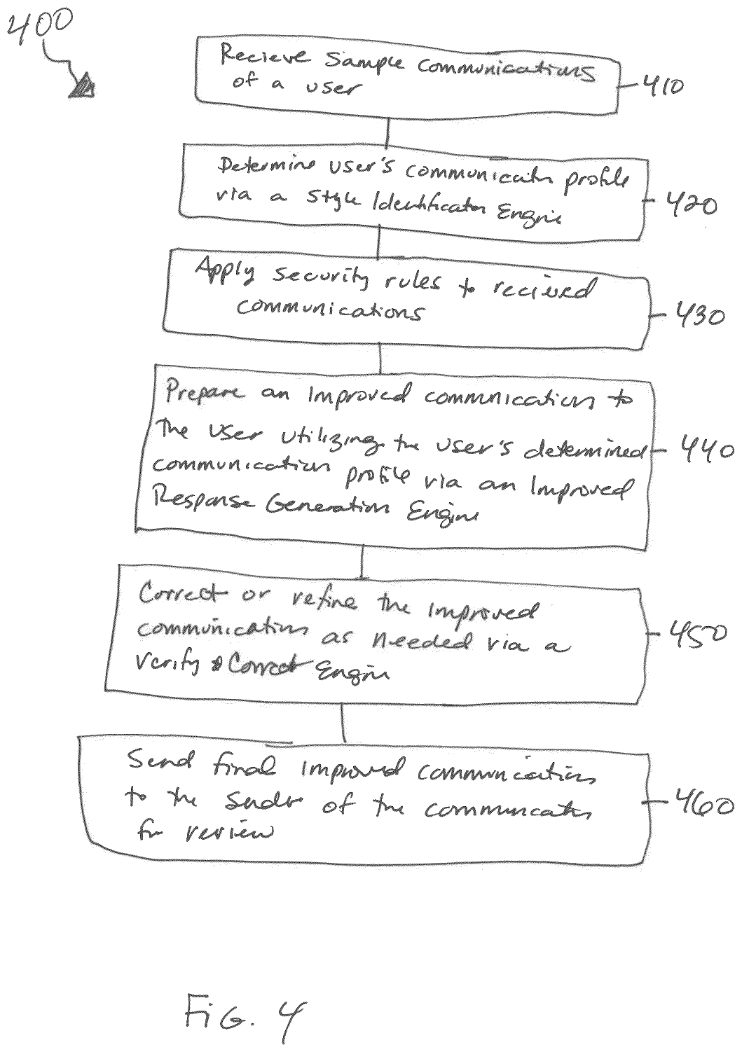

Behavioral Psychology Modeling. A method of the present disclosure 400 may include, with reference to FIG. 4, receiving samples of user's electronic communications 410 and determining the user's communication profile via a style identification engine 420. Security rules may be applied to the received sample communications 430 to ensure that no information is improperly retained. Using the communication profile of the user, preparing an improved communication to the user based on the user's communication profile determined at step 420, whereby the improved communication is determined via an improved response generation engine 440. In some embodiments, the improved communication is corrected or refined by a verify and correct engine 450 prior to being sent to the sender of the communication to the user 460.

As discussed above, a large repertoire of work exists and has existed for decades relating to assessing and defining different personality types and/or communication styles, etc. In one framework, a person may be assessed and defined according to an ask/tell and emotive/control framework, which may be used in some systems and methods of the present disclosure. The ask v. tell continuum may be expressed as an assertiveness continuum that may encompass a spectrum of communication styles. At one end is “asking,” where individuals use polite language and seek consensus. On the opposite end lies “telling,” characterized by direct instructions and prioritization of efficiency. Effective communication dances between these two approaches, adjusting steps based on context and relationships.

Individual communications can be scored on the Ask/Tell continuum (for concreteness, 0 is extreme Ask, 100 is extreme Tell, and 50 is the midpoint), which can be combined to get a person's overall score. If a certain threshold of difference exists between sender and recipient, nudging would be used.

Individual communications can be scored on the emotive/control continuum (for concreteness, 0 is extreme Emotive, 100 is extreme Control, and 50 is the midpoint). If a certain threshold of difference exists between sender and recipient, nudging would be used.

In some embodiments, the style identification engine may profile users based on five key traits, though it will be understood that embodiments of the present disclosure may include identifying and categorizing people according to any known or later-arising framework. In embodiments that use five key traits, users may be profiled based on Openness, Conscientiousness, Extraversion, Agreeableness, and Neuroticism. Systems and methods of the present disclosure may create a profile by using the sample quantity of electronic communications. The system may analyze each sentence of an email and score it on these five axes using regression models trained by the inventive system. In some embodiments, sentences in an email may be scored and then aggregated at the email level.

In the framework discussed including five key traits, the traits may refer to the following: Openness to Experience-describes an individual's imagination and creativity, intellectual curiosity, and willingness to try new things. Proving behaviors include enjoying learning, having an active imagination, being creative, and thinking about abstract concepts. Disproving behaviors include disliking change, sticking to routines, and being more grounded.

Conscientiousness-refers to how thoughtful and goal-oriented an individual is, their control over impulses, organization, and work ethic. Proving behaviors include being optimistic, emotionally stable, well-organized, hardworking, detailed-oriented, good at planning, and mindful of deadlines. Disproving behaviors include being impulsive, having trouble focusing, being messy, and prone to procrastination.

Agreeableness-describes how an individual treats relationships with others-kindness, helpfulness, and valuing social harmony. Proving behaviors include being altruistic, empathetic, caring, compassionate, and trustworthy. Disproving behaviors involve being selfish, stubborn, competitive, manipulative, and suspicious.

Neuroticism-refers to a person's emotional stability and unsettling thoughts or moodiness. Proving behaviors include often feeling insecure, getting stressed easily, being irritable, and experiencing mood swings. Disproving behaviors include being optimistic, managing stress easily, and feeling relaxed.

Extraversion-reflects how a person interacts socially, their emotional expression, and comfort in their environment. Proving behaviors include being outgoing, talkative, thriving in social situations, enjoying being around people, and seeking excitement. Disproving behaviors include being introverted, preferring solitude, feeling tired after socializing, and preferring smaller groups.

To profile these traits, the profile identification engine may score each sentence in an email on the respective axis using regression models trained on synthetic data. The scoring process captures nuanced behavioral traits that contribute to the overall persona depicted in the electronic communication exchange.

In embodiments of the present disclosure, nudging may be used to help a sender communicate more effectively with a person of a given communication style. For example, a suggested email to a person who is an “ask” communication style on the continuum may read, “Hi David! I was wondering, if you have some free time today, if you could please give me the form I am missing. it would be really helpful for me to have. Can you please send it to me, if you're not busy? Thanks, Bill.” In contrast, a suggested communication to a person (a nudge that the application provides) that is more “tell,” may be provided by the system, such as, “Hi David, I need the missing form today. Please send it to me as soon as possible. Thanks, Bill.” As may be seen, the “asks” have turned to “telling.”

The emotive versus control continuum encompasses contrasting communication styles. On one end, emotive communicators openly express emotions, thrive on spontaneity, enthusiasm, and persuasion. Conversely, the control communication style appears composed but subtly asserts authority through indirect cues, prioritizing goals over feelings. An example according to systems and methods of the present disclosure may include a nudge to a sender of an email that has been determined to be more towards the emote end of the continuum that reads: “Hi David, I hope you're having a great day! I'm really in need of the missing form today. It would mean a lot to me if you could send it over as soon as you can. Thanks so much, Bill.” In contrast, if a sender is writing to someone who is more toward the control end of the continuum, a potential nudge of the email above may be, “Hi David, I need the missing form today. Please send it to me as soon as possible. Thank you, Bill”. Note that in the control version of the email, the emotiveness is gone.

Systems and methods to create training data and ML model creation, according to some embodiments. Data used in training behavior psychology models may be a mixture of synthetically labeled text with label parameters created using LLM like GPT-4 to generate sentences representing the extremes of each personality trait axis, according to some embodiments of the present disclosure. Each trait may align with specific behaviors, which may be randomly selected and defined for the LLM to generate extreme-point sentences. These sentences may be labeled accordingly: 1 for the targeted trait (e.g., Extraversion) and 0 for non-trait examples then ran through a regression algorithm. The technique involves providing definitions and variable prompts to the LLM, resulting in a more naturally separated set of sentences that illustrate behavioral extremes effectively. This method was found to yield better variability compared to fixed prompts previously tested.

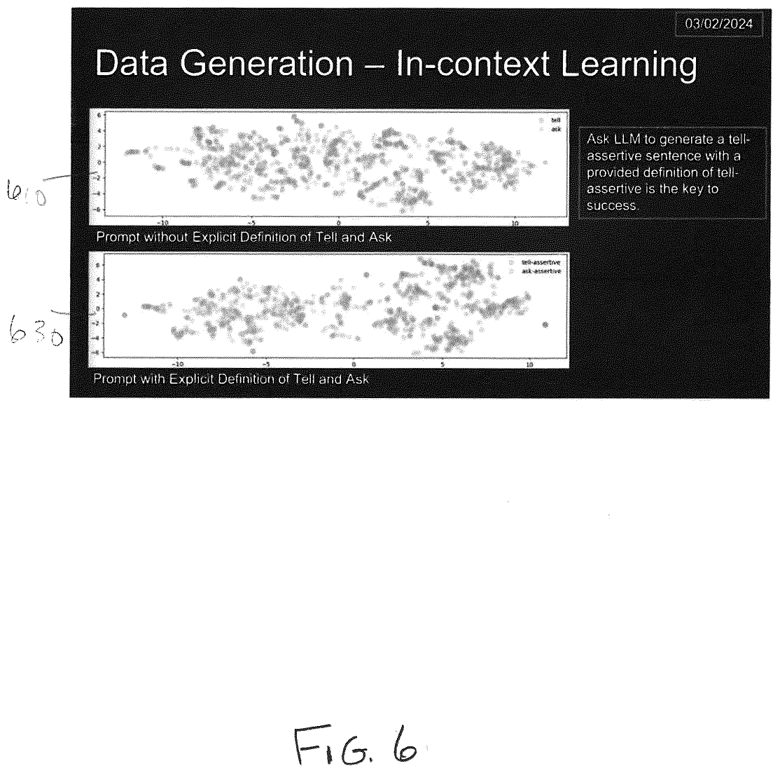

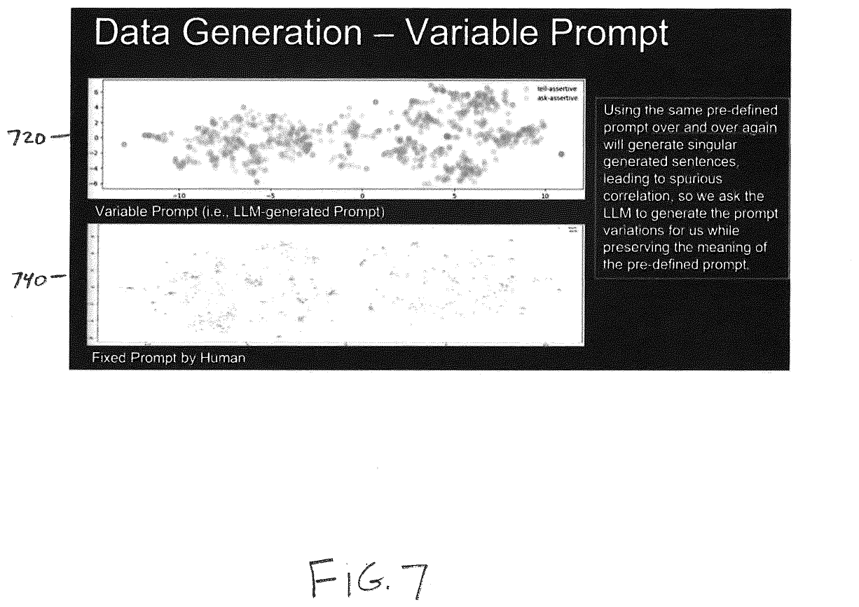

FIG. 6 shows a graphical comparison of providing the improved response generation engine with explicit definitions 610 of communication styles versus not providing such definitions 630, according to some embodiments of the present disclosure. FIG. 7 shows a graphical comparison of providing the improved response generation engine with variable 720 versus fixed 740 prompts, in accordance with some embodiments of the present disclosure.

In one embodiment, the model may be created by using algorithms found in the Azure ML platform, for example, to create classification and regression Machine Learning Models. Regression models can be trained using tens of thousands of labeled sentences that are generated for the model.

Model Validation. To create accurate machine learning models that can automatically label communication styles according to some embodiments of the present disclosure, the model should be validated through both automatic and/or manual means. A large language model may be used to automatically label various emails from public sources that have obvious leaning one way or another in the communication style to help check the validity of the model accuracy in the extremes of the communication spectrum. As additional validation, in some embodiments the model may further be improved through the use of behavioral psychology experts to manually label hundreds of sentences to compare it against the model output. Some embodiments of the present disclosure may only employ models where both the automatic and manual validation means result in high accuracy.

To further customize the system, AI using RAG may be used. In some embodiments, the system may include integration with company data in the workplace setting. Organizations can upload unstructured data to enrich LLM/Improved Response Generation Engine responses with context-specific information without retraining the model. The uploaded documents may be chunked into text and fed into a word embedding model, with the data stored in a vector database to enrich LLM Improved Response Generation Engine calls contextually. Embodiments may include team document sharing that allows shared documents within teams to enhance the draft and rewrite functions by quickly retrieving accurate product or company-specific information. Some embodiments may also include custom templates that enable the use of custom templates with specific documents for consistent and efficient email drafting.

In some embodiment of the present disclosure, the system analyzes at least four written communications, for example. The system may send these sample electronic communications to a large language model such as ChatGPT, for example, that may be incorporated into the Style Identification Engine, according to some embodiments. ChatGPT, for example, may be used to categorize the communication into one of a desired number of categories. For example, in some embodiments, the categories of interest may include ask/tell and people/data. In the following example according to some embodiments, the system may prompt the large language model of the Style Identification Engine with the following to determine David's communication type based on four e-mails he authored:

Prompt: Given these 4 Social Styles:

(1) Data-Tell Style. The Data-Tell Style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to get accomplished.

(2) People-Tell Style. The People-Tell Style is characterized by being enthusiastic and emotional. People of this style tend to make their feelings (both negative and positive) known to others and can seem to react impulsively to situations. Individuals with the Expressive Style are often perceived as personable, chatty, and sometimes opinionated.

(3) People-Ask Style. People with the People-Ask Style openly display their feelings to others. People with this style are often perceived as agreeable, informal, easy-going, and generally seem less demanding than others. They tend to prioritize relationships, and they need to feel personal security in order to perform their work.

(4) Data-Ask Style. Individuals with a Data-Ask Style are characterized by their tendency to look hard at the data and sometimes be cautious. People with this style are often perceived as quiet, logical, and sometimes reserved, and they tend to want to make sure they're correct before making a decision. Individuals with this style may not initiate communications unless they see a specific need to do so.

In this example, David has written the following emails: Email 1: “CC′ing Alvin, can we look at that outstanding balance? Thanks, David.”

Email 2: “Hey Tara and Jodie! As a heads up, our ACATs to DriveWealth will most likely be completed next month, in July, and not this month. Considering our recent trade issues, and that we're not adding new accounts but just going to be leaving, can we have a discount on our July bill? Thank you, David.”

Email 3: “Thanks! Anything for the email? And just confirming the address as XXXX. We are going to use ACAT, so is 1234 your ACAT clearing number?”

Email 4: “Hey all! We're getting ready to get ACAT forms signed. Can I verify the below info is what we should have on Drivewealth's ACAT forms? That address/phone number correct? Can I get an email and ACAT clearing number for Apex? Thanks, David.”

Based on the above prompt and these four emails, the system may provide the following assessment with a high level of certainty—that David's social style is Data-Ask. Rationale for this determination includes that David is task oriented. All of his emails are focused on specific tasks, such as getting the outstanding balance looked at, requesting a discount on his July bill, confirming the address and ACAT clearing number for Apex Clearing, and verifying the information on Drivewealth's ACAT forms.

David is cautious. He asks clarifying questions in all of his emails, such as “Anything for the email?” and “That address/phone number correct?” This suggests that he wants to make sure he has all of the information before making a decision.

David is logical. He uses clear and concise language in his emails, and he avoids using emotional language. This suggests that he is thinking things through logically before he communicates them. As such, in this example, based on four e-mails David authored, he was categorized as a Data-Ask type communicator by the system according to one embodiment.

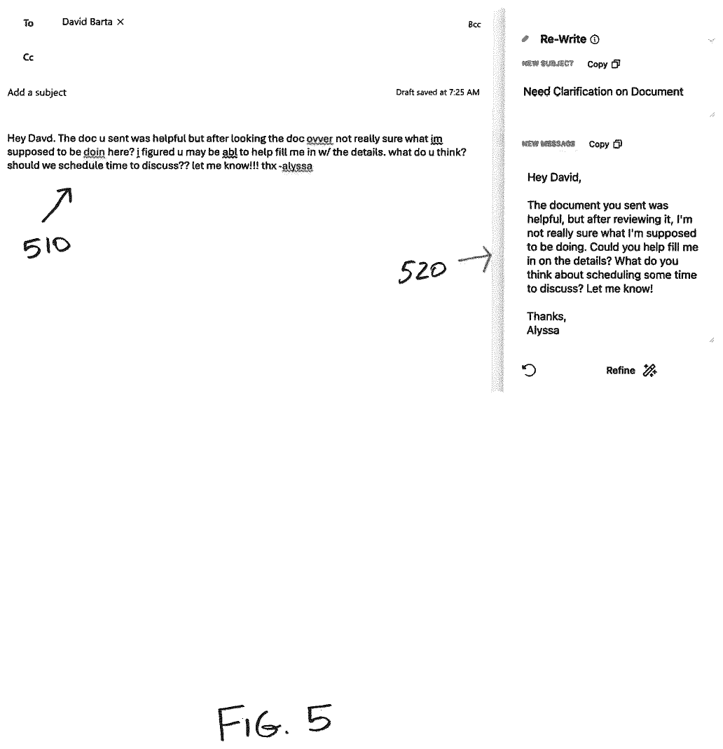

Embodiments of systems and methods of the present disclosure enable the system to suggest modifications to a written communication based on the recipient's communication type as determined by the system. In one embodiment, the rewriting of a communication to individuals modeled in the four or five or more (or less) quadrants is accomplished by sending a prompt to a large language model and/or other modules of the Improved Response Generation Engine and the response may be used to provide modifications to the written document. The system works in the background and when the user starts to draft a new e-mail or responds to an e-mail, the system automatically monitors the draft. In one embodiment, the system reminds the drafter of the communication type of the recipient based on the system's analysis of at least some of the e-mails authored by the recipient. Then, the system sends the Improved Response Generation Engine, a prompt to determine the appropriate modifications. For instance, as shown in FIG. 5, an initial email 510 has been rewritten in an improved style that is more suited to the recipient's communication style 520.

With a click of a button, the author may accept the suggested rewrites, reject them, or alter them. The author also has the ability to accept one or more of the suggested modifications. An advantage of certain embodiments of the present disclosure is that it provides an easy-to-use tool that runs in the background that provides the author with a rewritten e-mail or portions thereof that the recipient should understand much better, because it is written in the recipient's communication style. In short, in one embodiment of the present disclosure, the system is monitoring the drafting of an e-mail to the recipient; when the system determines that a drafter has stopped typing, the system may send a drafted version to a large language model and/or additional modules of the improved response generation engine, then upon receiving a response of a rewritten version of the draft sent to the improved response generation engine, the system provides this version to the drafter. With a click of a button, the drafter can accept and send the revised version.

In the following example, the query below was sent to a large language model, and/or additional modules of the improved response generation engine. Prompt: “I need to send a message to a colleague whose social style is Data-Tell. The Data-Tell style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to accomplish.

The following is the initial (unaltered) message: “Solidifying DW integration timeline, we may need to push 1-2 weeks, we need to push because we believe our estimates of the time to go through Drivewealth's certification program to get production keys to be too aggressive, so we want to extend our timeline to what we think has the highest probability of actually happening. And if there is a clear pattern for how DW account numbers are created, we can accurately guess what they will be now and use them on our ACAT forms. If there isn't a clear pattern, we will have to wait until post-certification, and then we'll create the accounts, get the actual DW account numbers, put them on our ACAT transfer forms, and then send the DocuSign forms to clients.” Then prompt the LLM with, “can you rewrite my message so my colleague with the driving style will understand better?”

The system may return with the following suggested email: “Subject: DW Integration Timeline Update: Hi [colleague's name], I'm writing to update you on the DW integration timeline. We're now projecting a 1-2 week delay. The reason for the delay is that our estimates for the time it takes to go through Drivewealth's certification program were too aggressive. We want to extend our timeline to what we think has the highest probability of actually happening. If there is a clear pattern for how DW account numbers are created, we can accurately guess what they will be now and use them on our ACAT forms. This will save us time and ensure that we can start transferring client accounts as soon as possible. If there isn't a clear pattern, we'll have to wait until after certification. At that point, we'll create the accounts, get the actual DW account numbers, put them on our ACAT transfer forms, and then send the DocuSign forms to clients. I'll keep you updated on our progress. Thanks, [Your name].”

Specific changes made to the message by the system to make it more clear and concise for a data-tell style colleague include: starting the message with a clear subject line that summarizes the main point of the message: getting to the point quickly and avoided using jargon or technical terms: using clear and concise language: emphasizing the actions that need to be taken; and ending the message with a call to action.

The system uses this response from the improved response generation engine and presents it to the author for the author to accept as a whole or to accept portions. The system enables the author to change the communication to the suggested communication with a single click in some embodiments. Because all of the analysis was being done in the background, the experience is seamless to the author, i.e. the prompts to the improved response generation engine do not come from the user, but from the system. In some embodiments, however, prompts may come, or may also come from a user, for example, a user may provide a prompt through a user interface to generate an email with a given set of information according to a particular recipient's communication style.

In the embodiment described above, the system determines a person's communication type in one of four quadrants. In another embodiment, the system can further define an individual's characteristics which may further refine the communication type of the individual. That is, within a single quadrant there may be much variation (not all Data-Tells are the same). So, in one embodiment, the system addresses this variation by modeling for specific characteristics within a quadrant or across the quadrants. The system can model the top five (or ten or any number) communication characteristics that an individual demonstrates in their written communication. This is a far more nuanced and individualized model. And not all five characteristics need to come from the same quadrant, they could be from all four quadrants. This allows the system to further define a more unique model of the recipient's communication style. The following example shows modeling an individual based on prior written e-mails using a large language model as part of the Style Identification Engine.

In this example, the following information was provided to the system for these 4 communication styles, Data-Tell, People-Tell, People-Ask, Data-Ask: START OF Data-Tell Style Characteristics. The Data-Tell Style is characterized by being decisive, fast-paced, and sometimes controlling. People with this style are perceived by others as action-oriented, direct, forceful, and determined. Extremely goal-oriented, they tend to focus their effort (and the efforts of others) on the objectives they want to get accomplished. With high assertiveness and low emotional response to others, Data-Tells are not so worried by how others react and are hence more independent and candid. With less concern about people, they have a greater concern for results and are quite pragmatic. They may also be poor collaborators and upset others with inconsiderate words and actions. They may be competitive and need to win, seek control and being in charge. They may be fast-acting, plan carefully, be decisive, results-oriented, and task-focused. They may dislike inefficiency and indecision. They can be impatient and insensitive. When stressed they may grab control and be overly critical.

The Data-Tell social style is more task-oriented, and more ‘tell’ oriented. Data-Tells are: Fast-paced. They will make quick decisions, speak quickly, walk quickly and they will expect deliverables “yesterday.” Action-oriented. They have a “better to do something rather than nothing” orientation. They will not always get it right, but that is not their goal, a good hit-rate is enough. Decisive, but willing to shift quickly. A Data-Tell has strong opinions, but if they see that their approach is not working, they are willing to adapt quickly (which can surprise and alarm other styles!). Highly independent. They want to be in control, and they are focused on the bottom line. This can backfire if they do not consider the needs of other people that they depend on. END OF Data-Tell Style Characteristics

START OF People-Tell Style Characteristics. The People-Tell Style is characterized by being enthusiastic and emotional. People with this style type tend to make their feelings (both negative and positive) known to others and can seem to react impulsively to situations. Individuals with the People-Tell Style are often perceived as personable, chatty, and sometimes opinionated. People-Tell people have higher assertiveness and greater responsiveness to others. With less concern for what others think they are typically articulate, quick and visionary. On the downside, their assertiveness may make them poor listeners and with a tendency to distract. This can also lead them to be impractical and impatient. They are typically, intuitive, creative, outgoing and enthusiastic, spontaneous and fun-loving. They interact well with others at work, are good at persuading and motivating, fear being ignored or rejected, but like to be acknowledged. They dislike routine and complexity, have a tendency to generalize and exaggerate, and when they are stressed may get sarcastic and unkind.

The People-Tell social style is people-oriented, and more ‘tell’ oriented. Analytics for this style include: ‘Big ideas’ people. People-Tells like bold ideas, big statements, and eye-catching projects. Impulsive. They go with their gut on what is right. As a result, they make more mistakes than most, but view this as part of getting things done. They are easily bored too, and do not do details. Full of energy. They talk first, think later and are bristling with energy and enthusiasm. They are always ready to embrace the next big thing. They share their emotions openly. Energized by connections. They will pick up the phone rather than send an email, and they would much rather meet face-to-face and talk. End OF People-Tell Style Characteristics.

START OF People-Ask Style Characteristics. People with the People-Ask Style openly display their feelings to others. People with this style are often perceived as agreeable, informal, easy-going, and generally seem less demanding than others. They tend to prioritize relationships, and they need to feel personal security in order to perform their work. People with higher responsiveness than others and lower assertiveness are people-oriented and sociable. Without a need to lead, they can be steady and reliable workers. They may also avoid any conflict and be rather passive, lacking drive and becoming careless. They may typically include the following traits: friendly and relates well to others, good at listening and teamwork, wants to be respected, liked and approved of, dislikes conflict and risk-taking, seeks security and likes organized workplaces. They may be slow decision-makers, prefer to be told what to do rather than lead, fear change and uncertainty; and when stressed may become indecisive and submissive. The People-Ask social style is people-oriented, and ‘ask’ oriented. People-Asks are typically: Warm, friendly, and easy-going. They are sensitive to other people's feelings and emotions. Team-players. They are generous with their time and want to hear from others. They value making decisions by consensus. Relationship-focused. This is a strength but can also lead to an unwillingness to confront performance issues. Risk-averse. They work best in a stable environment and will seek to reduce risk in decision-making. END OF People-Ask Style Characteristics

START OF Data-Ask Style Characteristics. Individuals with a Data-Ask Style are characterized by their tendency to look hard at the data and sometimes be cautious. People with this style are often perceived as quiet, logical, and sometimes reserved, and they tend to want to make sure they're correct before making a decision. Individuals with this style may not initiate communications unless they see a specific need to do so. Data-Ask people are less assertive and less responsive to others. They hence tend to focus more on tasks than people and are less interested in leading, being happier to work by themselves. They may be prudent and systematic, making them good at analytic work. They may also pay excessive attention to detail in ways that annoy others. People of this character type may typically: focus on tasks more than people, like to be right and will take time to ensure this, be thoughtful, careful fact-oriented and precise, good at objective evaluation and problem-solving, likes organization and structure, avoid group work, preferring to work alone. They can be over-critical and unresponsive, cautious in decision-making, and when stressed may withdraw or become headstrong. The Data-Ask social style is equally task-oriented, and more ‘ask’ oriented. Analytics for this type include: Highly focused. They set high standards (for themselves and others), they are detail oriented and expect to deliver quality work. Data oriented. They want to make decisions based on data, the more the better. Systematic and well organized. They like to take a structured approach and methodical approach. Introverts. They are quiet and private by nature, preferring to work alone or in small groups. Their quiet style may make them seem reserved. End OF Data-Ask Style Characteristics.

David's sample emails provided to the Style Identification engine along with the above definitions include: Email 1: “CC′ing Alvin, can we look at that outstanding balance? Thanks, David.” Email 2: “Hey Tara and Jodie! As a heads up, our ACATs to DriveWealth will most likely be completed next month, in July, and not this month. Considering our recent trade issues, and that we're not adding new accounts but just going to be leaving, can we have a discount on our July bill? Thank you, David.” Email 3: “Thanks! Anything for the email? And just confirming, XXX, We are going to use ACAT, so is 1234 your ACAT clearing number?” Email 4: “Hey all! We're getting ready to get ACAT forms signed. Can I verify the below info is what we should have on Drivewealth's ACAT forms? That address/phone number correct? Can I get an email and ACAT clearing number for Apex? Thanks, David.”

The system may be prompted to provide the top five most recurring characteristics David expresses in his emails and which primary communication style each characteristic relates to. As well as which communication style David displays most frequently.

The system provides the following information, including the top five most recurring characteristics and the primary communication style each characteristic relates to:

| Characteristic | Social Style |
|---|---|
| Direct and to the point | Data-Tell |
| Task-oriented | Data-Tell |
| Fact-oriented | Data-Ask |
| Organized and structured | Data-Ask |
| Concise | Data-Ask |

In aggregate, David displays the Data-Ask communication style most frequently. This is evident in his emails, which are typically direct, task-oriented, fact-oriented, organized, and concise. David also tends to use a lot of acronyms and abbreviations in his emails, which is another characteristic of the Data-Ask social style.

Here are some specific examples of how David's emails exhibit the Data-Ask social style:

In Email 1, David uses the acronym “ACAT” to refer to the Automated Customer Account Transfer process.

In Email 2, David provides a detailed list of the trade issues that have affected his company.

In Email 3, David asks for specific information about Apex Clearing's address, phone number, and ACAT clearing number.

In Email 4, David asks for confirmation that the information he has provided is correct. Overall, David's emails are well-organized and concise, and they focus on the task at hand. This suggests that David is a Data-Ask communication style.

As the example shows, the system defined the communication style by identifying five characteristics based on the analysis of four e-mails authored by the person. As the example shows, the characteristics were across two different quadrants. This refinement will further refine the rewrites of e-mails to this person.

The following shows an example of how the system proposes rewrites of an e-mail to a recipient modeled for his/her communication style as described above. With this more detailed model of an individual's communication style, the system can rewrite text in a far more nuanced and personalized way to the recipient, thus leading to an improved communication beyond merely the quadrant model. The following is an example of such a rewrite: Prompt: rewrite an email for a colleague who displays these top five characteristics in their communication style: 1. Direct and to the point: 2. Task-oriented: 3. Fact-oriented; 4. Organized and structured: 5. Concise.

The original email reads: “Solidifying DW integration timeline, we may need to push 1-2 weeks, we need to push because we believe our estimates of the time to go through Drivewealth's certification program to get production keys to be too aggressive, so we want to extend our timeline to what we think has the highest probability of actually happening. And if there is a clear pattern for how DW account numbers are created, we can accurately guess what they will be now, and use them on our ACAT forms. If there isn't a clear pattern, we will have to wait until post-certification, and then we'll create the accounts, get the actual DW account numbers, put them on our ACAT transfer forms, and then send the Docusign forms to clients.” Prompt: rewrite my message so it uses the style of the top five characteristics of my colleague's communication style.

The system may respond with: “Subject: DW Integration Timeline Update. Hi [colleague's name], I'm writing to update you on the DW integration timeline. We're currently projecting a 1-2 week delay, due to our estimates of the time to go through Drivewealth's certification program to get production keys being too aggressive. As a result, we're extending our timeline to what we believe has the highest probability of actually happening. If there is a clear pattern for how DW account numbers are created, we can accurately guess what they will be now, and use them on our ACAT forms. If there isn't a clear pattern, we will have to wait until post-certification. At that time, we'll create the accounts, get the actual DW account numbers, put them on our ACAT transfer forms, and then send the Docusign forms to clients. I'll keep you updated on our progress. Thanks, [Your name].”

This email is more direct and to the point by stating the main message in the first sentence. It is also more task-oriented by focusing on the specific tasks that need to be completed. The email is fact-oriented by providing specific details about the timeline and the account number pattern. It is organized and structured by breaking the information into clear paragraphs. Finally, the email is concise by avoiding unnecessary words and phrases.

This rewrite would be presented to the author and allows the author to accept, reject, or revise the rewrite with a click of a single button in some embodiments.

With the more advanced determination of communication style, the system can point out individual phrases that misalign with the recipient's communication style. With the more powerful top five (or any number) characteristic model of recipients' communication styles, the system can point out which sentences/phrases the sender has written that do not match and can recommend fixes. The previous examples have been about rewriting entire emails/text communications, this embodiment of the system and method is about phrases. This feature allows users to decide at what level they wish to modify their original message, at the phrase level (this point), or at the entire message level (prior points).

The following example is a prompt sent to a large language model/improved Response Generation Engine used by the system: Prompt: I have a message to send to my colleague. My Colleague's main communication traits are: 1. Direct and to the point: 2. Task-oriented: 3. Fact-oriented: 4. Organized and structured, and 5. Concise.

The original message reads: “Solidifying DW integration timeline, we may need to push 1-2 weeks, we need to push because we believe our estimates of the time to go through Drivewealth's certification program to get production keys to be too aggressive, so we want to extend our timeline to what we think has the highest probability of actually happening. And if there is a clear pattern for how DW account numbers are created, we can accurately guess what they will be now, and use them on our ACAT forms. If there isn't a clear pattern, we will have to wait until post-certification, and then we'll create the accounts, get the actual DW account numbers, put them on our ACAT transfer forms, and then send the Docusign forms to clients.” Prompt: point out every phrase or sentence that does not line up to one or more of my colleagues communication traits.

The system response may include the following: These phrases do not align: “Solidifying DW integration timeline, we may need to push 1-2 weeks”—This sentence is not direct and to the point. It could be improved by saying something like, “We need to push the DW integration timeline by 1-2 weeks.” “We believe our estimates of the time to go through Drivewealth's certification program to get production keys to be too aggressive”—This sentence is not fact-oriented. It could be improved by providing specific information about why you believe the estimates are too aggressive. For example, you could say something like, “Our estimates were based on the assumption that Drivewealth would process our application within 2 weeks. However, they have informed us that the current processing time is 4 weeks.”

“And if there is a clear pattern for how DW account numbers are created, we can accurately guess what they will be now”—This sentence is not concise. It could be improved by saying something like, “If we can identify a clear pattern for how DW account numbers are created, we can estimate the account numbers now.”

Here is the revised message that is more in line with your colleague's communication traits: “We need to push the DW integration timeline by 1-2 weeks. Our estimates of the time to go through Drivewealth's certification program to get production keys were too aggressive. If we can identify a clear pattern for how DW account numbers are created, we can estimate the account numbers now. If not, we will have to wait until post-certification to create the accounts and get the actual DW account numbers.”

This revised message is more direct, task-oriented, fact-oriented, organized, and concise. It is also more likely to be understood and appreciated by your colleague.

Separately, if a recipient has no e-mails, the system may access other sources to obtain samples, such as LinkedIn or other social platforms for the recipient and analyze the profile on LinkedIn to determine the recipient's communication style.

The system may be configured to determine communication styles based on existing e-mails and/or other electronic communication at the time the software is loaded on a user's computer or soon thereafter. Alternatively, the system may be configured to determine a recipient's communication's style at the time the author lists the recipient in the e-mail.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of scope of the invention, and what is intended by the applicants to be the scope of the invention, is the literal and equivalent scope of the set of claims that issue from this application, in the specific form in which such claims issue, including any subsequent correction.

What is claimed is:

1. A method of providing an improved electronic communication, comprising:
receiving a plurality of sample electronic communications for a recipient;
determining via a style identification engine a communication profile for the recipient based on the plurality of sample electronic communications;
receiving an initial electronic communication from a user to the recipient;
revising the initial electronic communication via an improved response generation engine to produce a suggested improved electronic communication that better reflects the recipient's determined communication profile;
providing the suggested improved electronic communication to the user.

2. The method of claim 1, where the step of determining the communication profile of the recipient comprises sending the style identification engine explicit definitions for a plurality of communication styles that make up the communication profile.

3. The method of claim 2, further including producing at least one action item for the user based on the initial or the improved electronic communication, and providing the at least one action item to the user.

4. The method of claim 2, further including producing at least one action item for the recipient based on the initial or the improved electronic communication and providing the at least one action item to the user.

5. The method of claim 2, wherein the initial electronic communication includes a plurality of individual electronic communications.

6. The method of claim 5, further including providing to the user a summary of the initial electronic communication, wherein the summary is provided according to the determined communication profile of the recipient.

7. The method of claim 1, further including providing on a user-interface of a computing device of the user the ability to accept, reject, or revise the improved electronic communication.

8. The method of claim 1, wherein the plurality of sample electronic communications from the recipient numbers at least four.

9. The method of clam of claim 1, wherein the suggested improved electronic communication is for an entirety of the initial electronic communication.

10. The method of claim 1, wherein the suggested improved electronic communication is for a portion of the initial electronic communication.

11. A system for providing an improved electronic communication that is tailored to a determined communication style of an intended recipient of the electronic communication, the system comprising:
a database to store a plurality of sample communications from at least one user;
a style identification engine, including software programmed such that when it is executed the style identification engine provides a determined communication style for each of the at least one user based on the stored plurality of sample communications of each of the at least one user, wherein the style identification engine includes a large language model module that receives explicit definitions for a plurality of communication types that make up the determined communication style; and
an improved response generation engine, including software programmed such that when it is executed, the improved response generation engine provides the improved electronic communication that includes changes from an initial electronic communication where the changes are in the determined communication style of at least of the users that is the intended recipient of the improved electronic communication.

12. The system of claim 11, wherein the user is an employee of a company, and wherein the initial electronic communication is a work-based communication.

13. The system of claim 12, further comprising an administrative panel module that is accessible by an administrator of the company, the administrative panel module including at least one policy document provided by the administrator of the company for use by the improved response generation engine.

14. The system of claim 13, wherein the at least one policy document includes a template that is used by the improved generation engine in providing the improved electronic communication.

15. The system of claim 13, wherein the at least one policy document includes at least one rule that is used by the improved generation engine to control a set of language that can be included in the improved electronic communication.

16. The system of claim 15, wherein the at least one rule prohibits the use of one or more words.

17. The system of claim 15, wherein the at least one rule defines at least one acronym.

18. The system of claim 1, wherein the improved generation engine provides to the user a summary of the improved electronic communication, and also provides at least one action item based on the initial electronic communication.

19. The system of claim 18, wherein the summary and the at least one action item are provided in any chosen language.

20. The system of claim 1, further comprising a verify and correct engine that receives the improved electronic communication from the improved response generation engine, the verify and correct engine including software that when executed identifies further improvements that can be made to the improved electronic communication, where the further improvements are based on the determined communication style of the recipient.
